(19) United States
(12) Patent Application Publication
(10) Pub. No.: US 2010/0116853 A1
(43) Pub. Date: May 13, 2010

(54) Apparatus for Dispensing Product

(76) Inventors: James C. Wightman, Livingston, NJ (US); Jeffrey Marc Hayet, Wayne, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/552,150

(22) Filed: Sep. 1, 2009

Related U.S. Application Data
(60) Provisional application No. 61/114,246, filed on Nov. 13, 2008.

(51) Int. Cl. B67D 3/00

(52) U.S. Cl. 222/525; 222/94; 222/129

(57) ABSTRACT

A product dispensing apparatus that may include a container unit, collar unit, plunger, and housing unit, wherein the product dispensing apparatus can transition between all open position and a closed position. In the open position, a product housed in the container unit may be dispensed from a product dispensing unit. In the closed position, the product is restricted from being dispensed from the product dispensing unit. The housing unit is be used to transition the product dispensing apparatus between the open position and the closed position without additional manual intervention. The process of engaging the product dispensing unit to the housing unit causes a physical interaction between the housing unit and the product dispensing unit to transition the product dispensing apparatus from the open position to the closed position.

### CROSS-REFERENCE TO RELATED APPLICATION

This application claims the benefit of U.S. Provisional Application No. 61/114,246, filed on Nov. 13, 2008. The entire disclosure of U.S. Provisional Application No. 61/114,246 is incorporated by reference herein.

### FIELD OF THE INVENTION

The present invention relates to an apparatus for dispensing product, more particularly, to a product dispensing unit capable of being transitioned between an open position and a closed position through the use of a housing unit.

### DESCRIPTION OF RELATED ART

Product dispensing containers are known in the art to allow for housing and dispensing of a fluid product. Most product dispensing containers provide a reservoir for housing the product and an outlet where the product is dispensed. The product is often dispensed from a product dispensing unit through a spout or like structure.

Conventional product dispensing containers often include a lid that receives the spout portion of the product dispensing container. By receiving the spout portion of the product dispensing container, the lid provides protection for the spout and may work toward confining discharges from the spout to the interior of the lid.

Product dispensing containers often allow users to adjust the spout so as to restrict the flow of product from the product dispensing container. In order to reduce the likelihood that product may be dispensed from the spout while inside the lid, conventional product dispensing containers require a user to transition the spout into a position that will restrict the flow of product before inserting the spout into the lid. Conversely, after a conventional product dispensing container is removed from its lid, the user must readjust the spout in order to allow the spout to dispense product.

One example of a conventional product dispensing container lid is described in U.S. Patent Publication No. 2003/0041870 (herein “Su”). The lid described in Su is configured to receive two cosmetic application devices. However as shown in FIG. 8 of Su, the product dispensing container is open and the product is exposed while in the lid. As a result, to ensure that the product is not discharged into the interior of the lid described in Su, a user must manually close the spout of the product dispensing unit before loading the product dispensing container into the lid. Conversely, a user must manually open the spout after removal from the lid in order to use the flow of product.

As demonstrated, the prior art lacks an apparatus that provides a housing unit in combination with a product dispensing unit wherein the housing unit is adapted to transition the configuration of the product dispensing unit such that the product dispensing unit is closed when in the housing unit and open (i.e., ready to use) when removed from the housing unit.

### SUMMARY OF THE INVENTION

Embodiments of the present invention satisfy these needs and other needs by providing an apparatus that allows for a product dispensing unit that is transitioned between and open and closed position through the use of a housing unit.

According to an embodiment of the present invention, the product dispensing unit may have an ‘open position’ and a ‘closed position.’ In the open position, product is free to exit the product dispensing unit through a dispensing site. In the closed position, the flow of product through the product dispensing unit is restricted and, as a result, product can not exit the product dispensing unit.

According to an embodiment of the present invention, the product dispensing unit is configured to be engaged with a housing unit. The process of engaging the product dispensing unit in the open position to the housing unit causes a physical interaction between the housing unit and product dispensing unit. As a result of this interaction, the product dispensing unit is transitioned from the open position to the closed position. Accordingly, the product dispensing unit is restricted from dispensing the product while secured to the housing unit, thereby preventing discharge of the product into the housing unit.

Conversely, the act of disengaging the product dispensing unit from the housing unit causes a physical interaction between the product dispensing unit in the closed position and a housing bracket of the housing unit to transition the product dispensing unit to an open position. In the open position, the product dispensing unit is free to allow the product to be discharged from the product dispensing unit.

Advantageously, according to one or more embodiments of the present invention, the user of the apparatus need not touch the spout portion of the product dispensing unit in order to transition the product dispensing unit between the open position and the closed position. Beyond the physical interaction between the product dispensing unit and the housing unit, no additional manual intervention is required to transition the product dispensing unit between the open position and the closed position. Transitioning the product dispensing unit to the closed position reduces the likelihood of unintentionally dispensing product.

### BRIEF DESCRIPTION OF THE DRAWINGS

The present invention will be more readily understood from the detailed description of exemplary embodiments presented below considered in conjunction with the attached drawings, of which:

FIG. 1 illustrates a product dispensing apparatus, according to an embodiment of the present invention;

FIG. 2 illustrates a product dispensing unit, according to an embodiment of the present invention;

FIG. 3 illustrates a perspective view of an exemplary container unit of a product dispensing unit, according to an embodiment of the present invention;

FIG. 4A illustrates a side view of an exemplary collar unit portion of a product dispensing unit, according to an embodiment of the present invention;

FIG. 4B illustrates a cross-sectional side view of an exemplary collar unit of a product dispensing unit, according to an embodiment of the present invention;

FIG. 5A illustrates a side view of an exemplary plunger of a product dispensing unit, according to an embodiment of the present invention;

FIG. 5B illustrates a cross-sectional side view of a plunger of a product dispensing unit, according to an embodiment of the present invention;

FIG. 6 illustrates a cross sectional side view of an exemplary dimpled dispensing assembly of a product dispensing unit, according to an embodiment of the present invention;

FIG. 7 illustrates a cross sectional side view of an exemplary smooth dispensing assembly of a product dispending unit, according to an embodiment of the present invention;

FIG. 8 illustrates a perspective view of a housing unit of a product dispensing apparatus, according to an embodiment of the present invention; and

FIG. 9 illustrates a cross sectional side view of an exemplary product dispensing apparatus comprising to receive two product dispensing units, according to an embodiment of the present invention.

### DETAILED DESCRIPTION OF THE INVENTION

The present invention relates to a product dispensing apparatus configured to contain and dispense a product. As used herein, the term “product” is intended to include, but is not limited to, any fluid substance, including gels, creams, cosmetics, therapeutic remedies, medicine, and food items. The product dispensing apparatus includes a product dispensing unit designed to engage with a housing unit, whereby the physical interaction associated engagement transitions the product dispensing unit into a closed position, thereby preventing the flow of the product from the product dispensing unit.

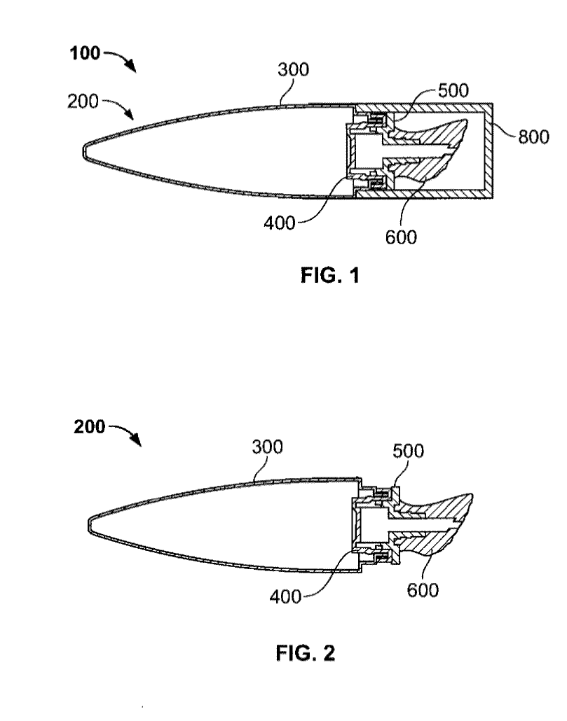

FIG. 1 depicts an exemplary product dispensing apparatus 100 according to an embodiment of the present invention. The product dispensing apparatus 100 comprises a housing unit 800 and a product dispensing unit 200, wherein the product dispensing unit 200 includes a container unit 300, a collar unit 400, and a plunger 500. According to an embodiment of the present invention, a portion of the product dispensing unit 200 is adapted to engage with the housing unit 800, as shown in FIG. 1. As a result of a frictional interaction between the container unit 300 and the housing unit 800, the product dispensing unit 200 remains securely attached to the housing unit 800. Optionally, as shown in FIG. 1, the product dispensing apparatus 100 may comprise a dimpled dispensing assembly 600.

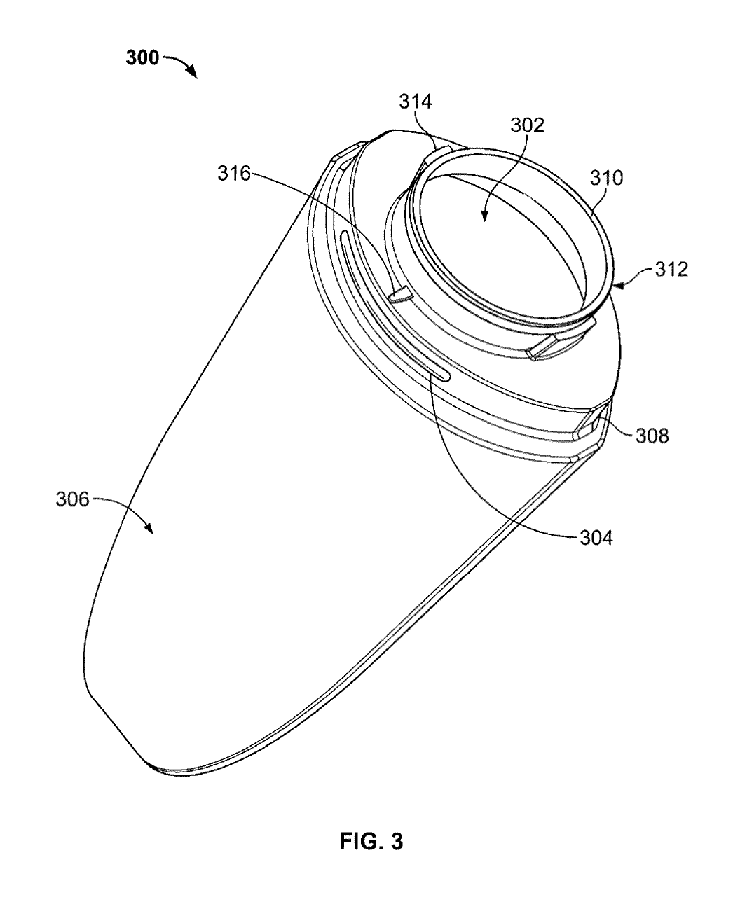

FIG. 2 depicts the product dispensing unit 200, according to an embodiment of the present invention. Product dispensing unit 200 comprises container unit 300, collar unit 400, plunger 500, and dimpled dispensing assembly 600. The functionality and interconnections between these elements are described in further detail below.

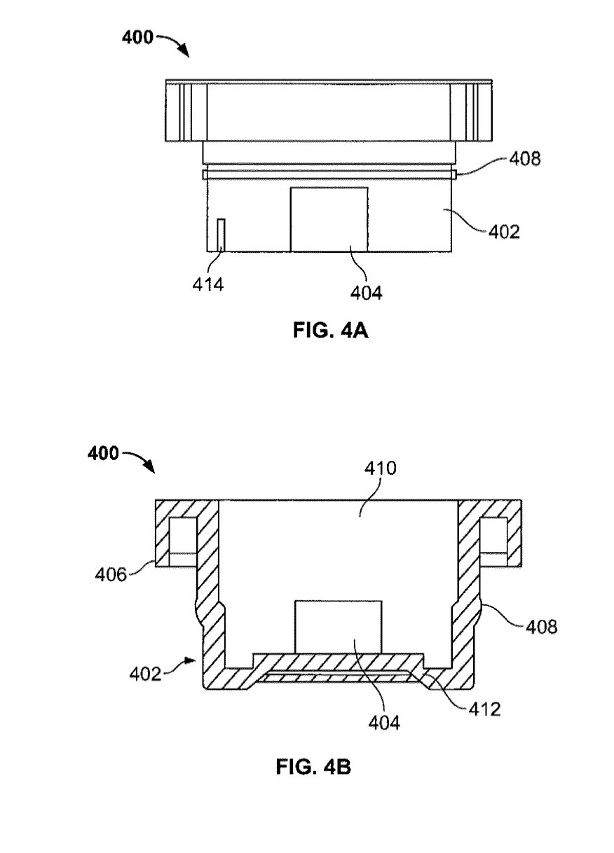

FIG. 3 depicts the container unit 300 according to an embodiment of the present invention. The container unit 300 comprises a cavity 306 adapted to house the product. The container unit 300 further comprises an opening 302, located at a first end of the container unit 300. The opening 302 provides a port at the first end of container unit 312 where the product can enter and exit the cavity 306. In addition, the opening 302 provides a point at which the collar unit 400 may engage with the container unit 300, as described below in connection with FIGS. 4A and 4B.

As shown in FIG. 3, the container unit 300 further comprises a first rib 304. As depicted in the embodiment of the present invention illustrated in FIG. 3, the first rib 304 is provided on a surface of the first end 312 proximate to opening 302. The first rib 304 may be a small lip or protrusion extending from the outer surface of the first end 312. According to an embodiment of the present invention, container unit 300 may comprise two first ribs 304 partially surrounding the opening 302. In alternative embodiments of the present invention, the first rib 304 or a plurality of first ribs 304 may be present. The housing unit 800 may engage with the first rib 304 in order to secure the housing unit 800 to the container unit 300. As discussed in further detail below, in certain embodiments of the present invention, the first rib 304 may engage with the housing unit groove 804 to aid in securing the housing unit 800 to the container unit 300.

According to an embodiment of the present invention, as shown in FIG. 3, the container unit 300 may include dual-layered contouring at the first end 312 of the container unit 300. The dual layer contouring includes a lower layer 308 and an upper layer 310. According to an embodiment of the present invention, the outer circumference of both the lower layer 308 and the upper layer 310 is less then the inner circumference of the receiving portion 802 of the housing unit 800. As a result, the housing unit 800 may securely engage with the first rib 304 located on the lower layer 308 while providing a flush orientation between the outer surface of container unit 300 and the housing unit outer surface 808.

According to an embodiment of the present invention, as shown in FIG. 3, the first rib 304 is located on the lower layer 308. Optionally, a first stabilization member 314 may be located on the upper level 310. One or more first stabilization members 314 engage with the collar unit 300 in order to help secure the collar unit 400 to the container unit 300. In particular, the interaction between the first stabilization members 314 and the collar unit 400 reduces the likelihood that the collar unit 400 will spin atop the first end 312 of the container unit 300. As discussed in further detail below, the stabilization engagement sites 406 (shown in FIG. 4B) included in collar unit 400 engage with first stabilization members 314 to help stabilize collar unit 400 to container unit 300.

In an alternative embodiment of the present invention, the container unit 300 may have two first stabilization members 314, wherein each of the two first stabilization members 314 are different sizes. Furthermore, collar unit 400 may have two stabilization engagement sites 406, wherein each of the two stabilization engagement sites 406 are different sizes. The sizes of the first stabilization members 314 and the stabilization engagement sites 406 correspond so that one of the stabilization engagement sites 406 is sized and shaped to engage with one of the first stabilization members 314, while the other stabilization engagement site 406 is sized and shaped to engage with the other first stabilization member 314. As a result of this relationship, the orientation of collar unit 400 and container unit 300 may be dictated by the fact that the stabilization engagement sites 406 and the first stabilization members 314 may only engage with each other in a single configuration.

In an embodiment of the present invention where the container unit 300 and the collar unit 400 may only engage with each other in a single configuration, the container unit 300 and the collar unit 400 may include alignment markers to aid in establishing the correct orientation when mating the container unit 300 to the collar unit 400. As seen in FIG. 3, the container unit alignment marker 316 may be located proximate to the first end 312. The corresponding collar unit alignment marker 414 may be located on the first engagement member 402, as shown in FIG. 4A. In such an embodiment, aligning the container unit alignment marker 316 and the collar unit alignment marker 414 may ensure that the container unit 300 and the collar unit 400 are coupled in the proper orientation. In an alternative embodiment of the present invention, container unit 300 may include two container unit alignment markers used to orient with two collar unit alignment markers location on the collar unit 400 to ensure that the container unit 300 and collar unit 400 properly engage.

In an alternative embodiment of the container unit 300, a single layer portion may be located at the first end 312 of the container unit 300, as opposed to the dual-layer contouring depicted in FIG. 3. In such a single layer configuration, both the first rib 304 and the first stabilization members 314 may be located on the single layer.

The container unit 300 may be constructed from a material that allows for a user to apply pressure to the container unit 300 thereby resulting in the ejection of the product from container unit 300. Therefore, the container unit 300 may be constructed from a plastic or other compressible material. The application of pressure to the container unit 300 may result in movement of product from the cavity 306, through the opening 302 into the collar unit 400. From the collar unit 400, product may travel into the plunger 500 and exit the product dispensing apparatus 100 through the dimpled dispensing assembly 600.

According to an embodiment of the present invention, the shape of the container unit 300 may be slightly conical, as illustrated in FIG. 3. One skilled in the art will appreciate that the shape and size of the container unit 300 may vary.

Further depicted in the embodiment illustrated in FIG. 1 are the collar unit 400, the plunger 500, and the dimpled dispensing assembly 600. As described below in detail, these three elements facilitate the dispensing of the product from the container unit 300. As shown in FIG. 1, the collar unit 400 engages with the opening 302 to secure the collar unit 400 to the container unit 300. As discussed further below, in the open position, the collar unit 400 and the plunger 500 interact to provide for fluid communication between the cavity 306, the first channel 404, the second channel 502, and the third channel 602, thereby enabling the flow of product from the container unit 300 through the collar unit 400, the plunger 500, and the dimpled dispensing assembly 600. In the closed position, interaction between the collar unit 400 and the plunger 500 interrupts fluid communication between the cavity 306, the first channel 404, the second channel 502, and the third channel 602. One skilled in the art will appreciate that in alternative embodiments of the present invention, alternative dispensing assemblies may be mounted onto the plunger 500, including the smooth dispensing assembly 700 shown in FIG. 7.

FIG. 4A depicts an exemplary collar unit 400 according to an embodiment of the present invention. FIG. 4B illustrates a cross-sectional view of the collar unit 400 according to an embodiment of the present invention. The collar unit 400 comprises a first engagement member 402 and a first channel 404. The first engagement member 402 is a portion of the collar unit 400 configured to engage with the opening 302 of the container unit 300. A frictional connection between the first engagement member 402 and the container unit 300 secures the collar unit 400 to the container unit 300. In alternative embodiments of the present invention, the collar unit 400 may be embodied in a single piece or a plurality of pieces.

As depicted in FIGS. 4A and 4B, the collar unit 400 may comprise a collar rib, or protrusions from collar unit 400 that at least partially surrounds collar unit 400. In operation, when securing the collar unit 400 to the container unit 300, the one or more collar unit ribs 408 facilitate the creation of a fit between the collar unit 400 and the opening 302 of the container unit 300. The collar unit rib 408 may be a protrusion extending from the exterior surface of the collar unit 400. In alternative embodiments of the present invention, securing the collar unit 400 to the container unit 300 may result in the creation of an airtight seal. Contact between the opening 302 and the one or more collar unit ribs 408 stops the upward motion of the collar unit 400.

The first engagement member 402 comprises the first channel 404 which provides a path though which the product may flow out of cavity 306. In the open position, first channel 404 is in fluid communication with the cavity 306 and the second channel 502. One having ordinary skill in the art will appreciate that the first engagement member 402 may comprise any number of first channels 404 in fluid communication with the cavity 306.

As depicted in FIG. 4B, embodiments of the collar unit 400 may include a stabilization engagement site 406 adapted to further the secure collar unit 400 to the container unit 300. When secured to the container unit 300, the stabilization engagement site 406 engages with the first stabilization member 314, thereby further securing the collar unit 400 to the container unit 300. The engagement between the first stabilization member 314 and the stabilization engagement sites 406 reduces the likelihood that the collar unit 400 will spin atop the container unit 300. In addition, the engagement between the first stabilization member 314 and the stabilization engagement sites 406 may help to ensure proper orientation between the collar unit 400 and the container unit 300. One skilled in the art will appreciate that in further alternative embodiments, other methods of securing the collar unit 400 to the container unit 300 may be used.

In an alternative embodiment of the present invention, the collar unit 400 may have two stabilization engagement sites 406, wherein each of the two stabilization engagement site 406 are different sizes. Furthermore, container unit 300 may have two first stabilization members 314, wherein each of the two first stabilization members 314 are different sizes. The sizes of the first stabilization members 314 and the stabilization engagement sites 406 correspond so that one of the first stabilization members 314 is sized and shaped to engage with one of the stabilization engagement sites 406, while the other first stabilization members 314 is sized and shaped to engage with the other stabilization engagement sites 406. As a result of this relationship, the orientation of the collar unit 400 and the container unit 300 may be dictated by the fact that the stabilization engagement sites 406 and the first stabilization members 314 may only engage with each other in a single configuration.

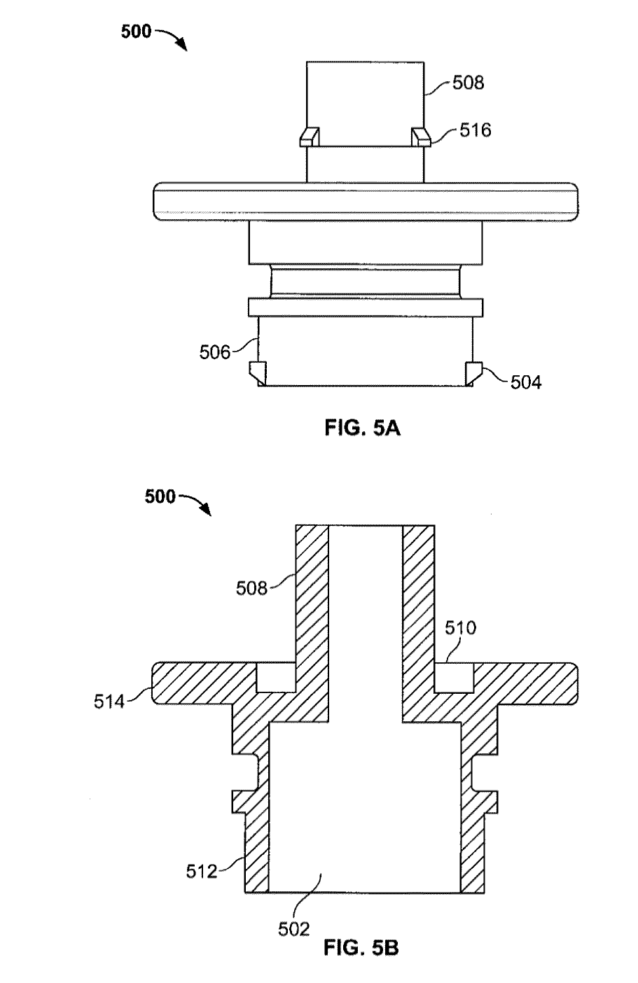

According to an embodiment of the present invention illustrated in FIG. 4B, collar unit 400 further comprises a receiving cavity 410. The receiving cavity 410 may be an area of collar unit 400 configured to receive the plunger 500, thereby allowing for a slideable connection between the collar unit 400 and the plunger 500. Opposite the open end of the receiving cavity 410 is a receiving cavity end 412. The receiving cavity end 412 is a portion of the collar 400 that may aid in creating a secure fit between the collar unit 400.and the plunger 500 when the product dispensing apparatus 100 is in the closed position. The receiving cavity end 412 may be configured to engage with the second end of the plunger 500 and may aid in restricting the flow of product through the product dispensing unit 200. The connection between the collar unit 400 and the plunger 500 is discussed below in greater detail in connection with FIGS. 5A and 5B.

FIG. 5A depicts an exemplary embodiment of the plunger 500. FIG. 5B illustrates a cross-sectional view of the plunger 500 from FIG. 5A rotated 90 degrees, according to an embodiment of the present invention. The plunger 500 may act as an intermediary between the collar unit 400 a dispensing assembly (e.g., 600 or 700). The plunger 500 comprises the second channel 502, the channel stopper 504, and the mounting post 508. In alternative embodiments of the present invention, the plunger 500 may be embodied in a single piece or a plurality of pieces.

Plunger 500 is configured to slideably connect with the receiving cavity 410 of the collar unit 400. This slideable connection aids in transitioning the product dispensing apparatus 100 between the open position and the closed position. Transition between the open position and closed position results in the channel stopper 504 engaging and disengaging with the first channel 404. In the open position, the channel stopper 504 is not engaged with the first channel 404. In the closed position, the channel stopper 504 is engaged with the first channel 404. Engagement between the channel stopper 504 and the first channel 404 aids in regulating the flow of the product through the product dispensing unit 200. In the closed position, the channel stopper 504 may be fully engaged with the first channel 404, thereby interrupting fluid communication between the cavity 306 and the first channel 404. As a result, little or no product may flow through the first channel 404. Sliding the plunger 500 away from the collar unit 400 transitions the product dispensing unit 200 from the closed position to an open position, thereby disengaging the channel stopper 504 from the first channel 404. The channel stopper 504 travels within the first channel 404 and when channel stopper 504 comes in contact with the top portion of the first channel 404, the motion of the collar 400 is stopped. According to an embodiment of the present invention, an o-ring, or similar structure, may be used in conjunction with the plunger 500 to create a tighter fit between the plunger 500 and the collar unit 400. In alternative embodiments of the present invention, there may be an airtight fit between the collar unit 400 and the plunger 500 when the product dispensing apparatus 100 is in the closed position.

In addition to regulating the flow of product, the interaction between the first channel 404 and the channel stopper 504 aids in securing the collar unit 400 to the plunger 500. As the plunger 500 slides away from the collar unit 400 the channel stopper 504 may engage with the first channel 404 to ensure that the collar unit 400 and the plunger 500 remain slideably connected.

In addition to the interaction between the first channel 404 and the channel stopper 504, a bottom end 512 of the plunger 500 may aid in restricting the flow of the product through the product dispensing unit 200. The bottom end 512 is a portion of the plunger 500 that surrounds a portion of the second channel 502. The receiving cavity end 412 is configured to engage with the bottom end 512. When the plunger 500 slides toward the collar unit 400, the receiving cavity end 412 engages with the bottom end 512 thereby creating a secure fit between the collar unit 400 and the plunger 500. This engagement between the receiving cavity end 412 and the bottom end 512 may aid in restricting the flow of the product through the first channel 404.

In an alternative embodiment of the present invention, the collar unit 400 may have two first channels 404, wherein each of the two first channels 404 are different sizes. Furthermore, plunger 500 may have two channel stoppers 504, wherein each of the two channel stoppers 504 are different sizes. The sizes of the first channels 404 and the channel stoppers 504 correspond so that one of the channel stoppers 504 is sized and shaped to engage with one of the first channels 404, while the other channel stopper 504 is sized and shaped to engage with the other first channel 404. As a result of this relationship, the orientation of the collar unit 400 and the plunger 500 may be dictated by the fact that the first channels 404 and the channel stoppers 504 may only engage with each other in a single configuration. In alternative embodiments of the present invention the collar unit 400 and the plunger 500 may integrated as a single structural element.

The second channel 502 is a hollow portion of plunger 500 that runs through the interior of the plunger 500. As illustrated in FIG. 5B, the second channel 502 may extend through the plunger 500 beginning at the bottom end 512 of the plunger 500 and terminating at the top end 514 of the plunger 500. The second channel 502 is a conduit traversing the interior of the plunger 500 which allows the product to flow therethrough.

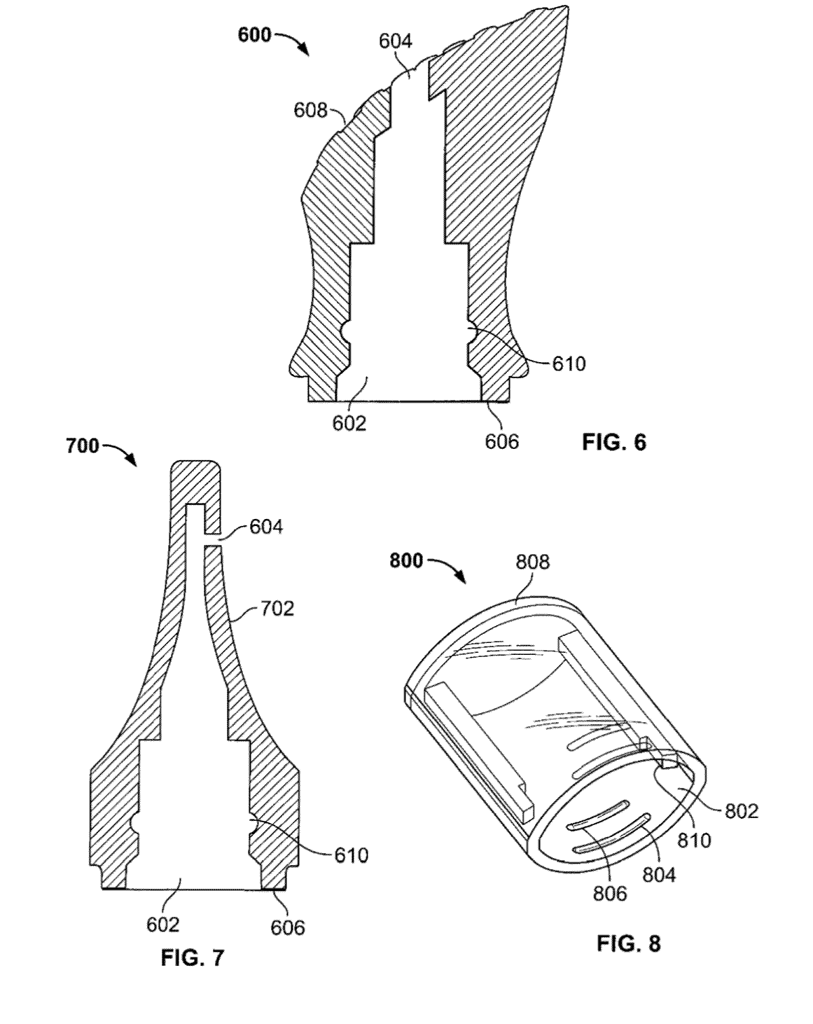

In addition to providing the termination point for the second channel 502, the top end 514 of the plunger 500 provides a location for the mounting post 508. The mounting post is an optional structure. In embodiments of the present invention including a mounting post 508, this structure may be a site at which a dispensing assembly (e.g., 600 or 700) may be mounted or slideably engaged. FIGS. 6 and 7 illustrate two exemplary embodiments of dispensing assemblies. A dispensing assembly may slideably connect to the mounting post 508. According to an embodiment of the present invention, the dispensing assembly may be further secured to the plunger 500 through use of a dispensing assembly engagement point 510. The dispensing assembly engagement point 510 may be located adjacent to the mounting post 508 and provide an area in which a portion of the dispensing assembly can engage with plunger 500 to further secure the dispensing assembly to plunger 500. In addition, the dispensing assembly engagement point 510 may assist in orienting the dispensing assembly for proper engagement with the plunger 500. One skilled in the art would appreciate that in alternative embodiments of the present invention, one or more dispensing assembly engagement points 510 may used to secure the dispensing assembly to the plunger 500.

In addition to dispensing assembly point 510, the plunger engagement member 516 may aid in securing the dispensing assembly to plunger 500. Located on the exterior of mounting post 508, plunger engagement member 516 is a protrusion from mounting post 508 configured to create a friction connection between the dispensing assembly and the plunger 500 thereby aiding in the act of securing the dispensing assembly to plunger 500.

A dispensing assembly may be any structure that further facilities the flow of the product through the product dispensing unit 200. A dispensing assembly is an optional structure and may be included in certain embodiments of the present invention. The structure of the dispensing assemblies may vary based on the product being dispensed or the method by which the product is applied.

FIG. 6 depicts an exemplary embodiment of the dimpled dispensing assembly 600 according to an embodiment of the present invention. The dimpled dispensing assembly 600 comprises a third channel 602, dispensing point 604, dispensing assembly engagement member 606, dimpled surface 608, and dispensing assembly groove 610. The third channel 602 provides a site for engagement between the mounting post 508 and the dimpled dispensing assembly 600. The mounting post 508 may engage with the third channel 602 to aid in securing the dimpled dispensing assembly 600 to the plunger 500. To further secure the dimpled dispensing assembly 600 to the plunger 500, the dispensing assembly engagement member 606 located at a first end of the dimpled dispensing assembly 600 may slideably engage with the dispensing assembly engagement point 510 located on the plunger 500. In addition, dispensing assembly groove 610 may create a friction connection with plunger engagement member 516 thereby aiding in the securing of plunger 500 to dimpled dispensing assembly 600.

In addition to providing an engagement point, the third channel 602 also creates a conduit providing a fluid communication path between the second channel 502 and the third channel 602 through which the product can flow from the plunger 500 into the dimpled dispensing assembly 600 and eventually exit the dimpled dispensing assembly 600 at the dispensing point 604 for application by the user. In some instances, the product may function better when the surface upon which the product is applied had been stimulated by dimples. As a result, the dimpled surface 608 may aid in application of the product.

Depending on the nature of the product, the dispensing assembly may be shaped and/or include a particular surface to facilitate improved product application. For example, certain products may require application with a smooth surface while other products may be more effective when the applicator comprises a rough or dimpled surface. As illustrated in FIG. 6, the dimpled dispensing assembly 600 includes the dimpled surface 608. The dimpled surface 608 may aid in the application of the product. An alternative dispensing assembly may include a smooth surface 702, as illustrated in FIG. 7. One skilled in the art would appreciate that alternative embodiments of the dispensing assembly may used in addition to those illustrated in FIGS. 6 and 7.

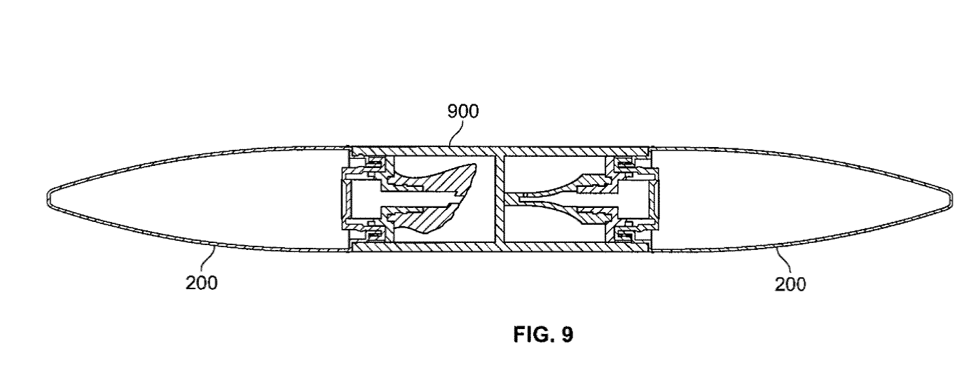

FIG. 8 illustrates the housing unit 800 according to one or more embodiment of the present invention. The housing unit 800 is configured to receive, secure, and engage with the product dispensing units 200. One skilled in the art would appreciate that an alternative embodiment of the housing unit could allow for a housing unit that receives more than one product dispensing units. As illustrated in FIG. 9, a dual cavity housing unit 900 may be configured to secure two product dispensing unit 200. Given that the elements related to the housing unit 800 are similar to those of the housing unit 900, the description of the elements in FIG. 8 apply to the like elements in FIG. 9.

The housing unit 800 comprises a receiving cavity 802, a first groove 804, and a second rib 806. The receiving cavity 802 is a portion of the housing unit 800 configured to receive a portion of the product dispensing unit 200, or like device. The receiving cavity 802 provides a site at which a portion of the product dispensing device 200 can enter the housing unit 800 when the apparatus is in the closed position.

The first groove 804 may be a recess located on an interior surface of the receiving cavity 802 configured to engage with the first rib 304 of the container unit 300. The engagement between the first rib 304 and the first groove 804 may aid in securing the product dispensing device 200 to the housing unit 800. In the embodiment of the housing unit 800 illustrated in FIG. 8, the first groove 804 is located between the second rib 806 and the opening of the receiving cavity 802.

The second rib 806 is a protrusion extending from the interior surface of the receiving cavity 802 configured to engage with the product dispensing unit 200 during the process of engaging and disengaging the product dispensing unit 200 from the housing unit 800.

The physical interaction between the product dispensing unit 200 and the housing unit 800 helps to facilitate transitioning the product dispensing unit 200 between an open and closed position. When the product dispensing apparatus 100 is in the open position, the plunger 500 is extended from the collar unit 400 and the channel stopper 504 is not engaged with the first channel 404. In this open position there is a fluid connection between the cavity 306, the first channel 404, the second channel 502, and the third channel 602. As a result, product may flow from the cavity 306 of the container unit 300, through the first channel 404, the second channel 502, the third channel 602, and exit the product dispensing unit 200 at the dispensing point 604. Release of the product may be initiated by the application of pressure to the container unit 300.

In order to transition the product dispensing unit 200 from the closed position to the open position, the plunger 500 slides away from the collar unit 400 and as a result the channel stopper 504 disengages from the first channel 404. As the product dispensing unit 200 is removed from the housing unit 800, the first rib 304 disengages from the first groove 804. This disengagement helps to release the product dispensing unit 200 from engagement with the housing unit 800. As the product dispensing unit 200 is further removed from the housing cavity 802, the second rib 806 frictionally contacts the top end 514 of the plunger 500, thereby causing the plunger 500 to slide away from the collar unit 400. Sliding of the plunger 500 away from the collar unit 400 disengages the channel stopper 504 from first channel 404. This disengagement allows for the establishment of a fluid connection between the cavity 306 and the first channel 404, thereby allowing for the flow of the product through the product dispensing unit 200. One of ordinary skill in the art will appreciate that the flow of the product may be initiated according to any known method, including, but not limited to applying pressure to container unit 300.

To transition the product dispensing apparatus 100 from the open position to the closed position, the product dispensing unit 200 is inserted into the receiving cavity 802. Upon insertion, the second rib 806 frictionally contacts the top end 514 of the plunger 500. As the product dispensing unit 200 is inserted further into the receiving cavity 802, the second rib 806 pushes on the plunger 500 thereby sliding the plunger 500 toward the collar unit 400. As the plunger 500 slides toward the collar unit 400, the channel stopper 504 engages with the first channel 404, thereby blocking the fluid connection between the cavity 306 and the first channel 404. Insertion of the product dispensing unit 200 into the receiving cavity 802 also causes the first rib 304 to engage with the first groove 804. The engagement between the first rib 304 and the first groove 804 secures the product dispensing unit 200 to the housing unit 800.

With reference to FIG. 8, in an alternative embodiment of the present invention, optional housing unit rails 810 may aid in transitioning the product dispensing unit 200 from the open position to the closed position. The housing unit rails 810 are structures that extend from the body of the housing unit 800 into receiving cavity 802. During insertion of the product dispensing unit 200 into the receiving cavity 802, the housing unit rails 810 engages with the top end 514 of the plunger 500, thereby applying a force to the plunger 500. As a result of this force, the plunger 500 slides toward the collar unit 400 and causes the channel stopper 504 to engage with the first channel 404. This engagement aids in transitioning the product dispensing apparatus 100 from the open position to the closed position. FIG. 8 illustrates the housing unit 800 as including two housing unit rails 810, however alternative configurations may include one housing unit rail 810 or more than two housing unit rails 810.

In additional alternative configurations, the housing unit rail 810 may not extend to the closed end of the housing unit 800. In such an embodiment, the housing unit rail 810 may be a structure that extends from the body of the housing unit 800 wherein the size and shape of the housing unit 810 rail such as to provide enough support to exert a force necessary to slide the plunger 500 toward the collar unit 400, or aid in this process.

In an alternative embodiment of the present invention, both the housing unit rails 810 and the second rib 806 may work together to apply a force to the plunger 500 that causes the plunger 500 to slide toward the collar unit 400. As a result the product dispensing apparatus 100 may be transitioned between the open position and the closed position.

In an alternative embodiment of the present invention, a single product dispensing unit 200 may be configured to house and dispense two products. In such an embodiment, the container unit 300 may be partitioned to allow for two products to be enclosed in container unit 300. In such a configuration, the two products would be restricted from coming in contact with each other while inside the container unit 300. In order to ensure that the two products do not come into contact with each other while traveling through the first channel 404, the second channel 502, the third channel 602, and the dispensing point 604, a partition may be present throughout the first channel 404, the second channel 502, the third channel 602, and the dispensing point 604. This partition will keep each product in a separate sub-channel as respective products travel through the product dispensing unit.

FIG. 9 depicts a dual housing unit 900 according to an embodiment of the present invention. As illustrated in FIG. 9, the dual housing unit 900 is configuring to receive two product dispensing units 200. In embodiments of the present invention where the dual housing unit 900 is configured to receive two product dispensing units 200, the dual housing unit 900 aids in transitioning two product dispensing units 200 between the open position and a closed position. The use of the dual housing unit 900 may be advantageous in instances where two products are used in connection with each other to provide therapeutic or cosmetic treatment (e.g. wrinkle cream, crow's feet reducer, or burn relief).

It is to be understood that the exemplary embodiments described herein are merely illustrative of the present invention and that many variations of the above-described embodiments may be appreciated by one skilled in the art without departure from the scope of the invention. It is intended that all such variations be included within the scope of the following claims and their equivalents.

1. A product dispensing apparatus adapted to transition between an open position and a closed position the product dispensing apparatus, comprising:
a product dispensing unit adapted to engage with a housing unit, wherein the product dispensing apparatus is in the closed position when the product dispensing unit is engaged with the housing unit and wherein the product dispensing apparatus is in the open position when the product dispensing unit is not engaged with the housing, the product dispensing unit comprising:
a container unit comprising:
a cavity configured to house the product,
a first end including an opening in fluid communication with the cavity, and
a first rib provided on an outer surface of the first end;
a collar unit comprising:
a first engagement member adjustably fitted within the opening of the first end of the container unit,
a first channel configured to be in fluid communication with the cavity when the product dispensing apparatus is in the open position, and
a plunger slideably fitted within the collar unit, the plunger comprising:
a second channel configured to align with the first channel when the apparatus is in the open position to allow the product to flow through the plunger, and
a channel stopper configured to engage with the first channel when the product dispensing apparatus is in the closed position to prevent the product from flowing through the plunger, and
the housing unit comprising:
a receiving cavity having an interior surface including a first groove and a second rib,
wherein the first groove is adapted to engage with the first rib of the container unit to securely fit the housing unit to the container unit when the product dispensing apparatus is in the closed position, and
wherein the second rib is configured to frictionally engage with the plunger upon introduction of the plunger into the receiving cavity to transition the product dispensing apparatus from the open position to the closed position.

2. The product dispensing apparatus of claim 1, wherein second rib is configured to frictionally engage with the plunger upon removal of the plunger from the receiving cavity to slideably transition the apparatus from the closed position to the open position.

3. The product dispensing apparatus of claim 1, wherein the plunger further comprises:
a mounting post provided on the top portion of the plunger configured to slidably engage with a dispensing assembly.

4. The product dispensing apparatus of claim 1, wherein the dispensing assembly further comprises:
a third channel configured to be in fluid communication with the second channel and slidably engage with the mounting post, and
a dispensing site configured to allow the product to exit the apparatus.

5. The product dispensing apparatus of claim 1, wherein the housing unit further comprises:
a second receiving cavity having an interior side surface including a second groove and a third rib,
wherein the second groove is adapted to engage with the first rib of the container unit to securedly fit the housing unit to the container unit when the product dispensing apparatus is in the open position, and
wherein the third rib is configured to frictionally engage with the plunger upon introduction of the plunger into the receiving cavity to slidably transition the product dispensing apparatus from the open position to the closed position.
